(19) United States
(12) Patent Application Publication
(10) Pub. No.: US 2026/0057610 A1
(43) Pub. Date: Feb. 26, 2026

(54) RELIABILITY CALCULATION DEVICE, THREE-DIMENSIONAL INFORMATION GENERATION DEVICE, AND RELIABILITY CALCULATION METHOD

(71) Applicant: JVCKENWOOD Corporation, Kanagawa (JP)

(72) Inventor: Tomoki SUGIYAMA, Yokohama-shi (JP)

(21) Appl. No.: 19/372,041

(22) Filed: Oct. 28, 2025

Related U.S. Application Data
(63) Continuation of application No. PCT/JP2024/014374, filed on Apr. 9, 2024.

(30) Foreign Application Priority Data
Jun. 7, 2023 (JP) 2023-093856

(51) Int. Cl. G06T 17/00; G06V 10/60; H04N 23/11

(52) U.S. Cl. CPC G06T 17/00; G06V 10/60; H04N 23/11

(57) ABSTRACT

A three-dimensional information processing device includes a first acquisition unit configured to acquire first point group data which is point group data of a subject acquired at a first zoom magnification by a first point group data acquisition device, a second acquisition unit configured to acquire second point group data which is point group data of the subject acquired at a second zoom magnification by a second point group data acquisition device acquiring point group data at an angle of view which at least partially overlaps the angle of view at which the first point group data is acquired by the first point group data acquisition device, and an identification unit configured to identify an overlapping portion out of point groups included in the first point group data and point groups included in the second point group data.

### DESCRIPTION

### TECHNICAL FIELD

The present invention relates to a reliability calculation device, a three-dimensional information generation device, and a reliability calculation method.

### CROSS REFERENCE TO RELATED APPLICATION

Priority is claimed on Japanese Patent Application No. 2023-093856, filed June 7, 2023, the content of which is incorporated herein by reference.

### BACKGROUND ART

In the related art, a method of calculating the distance to an object by emitting range-finding light to an object, receiving reflected light reflected by the object, and measuring a time from emission of light to reception of light is known. This range finding method is widely known as a time-of-flight (ToF) method. A technique of generating three-dimensional information of a subject by measuring distances from a plurality of viewpoints to a subject using such a range finding technique based on the ToF method and combining distance information from the plurality of viewpoints to the subject is known (for example, see Patent Document 1).

### Citation List

### Patent Document

Patent Document 1: Japanese Unexamined Patent Application, First Publication No. H7-174538

### SUMMARY OF INVENTION

As structural constraints when the range finding technique based on the ToF method is used, a probability error due to shot noise is known. When a subject includes a material which is likely to absorb infrared light or a material which is likely to transmit ultraviolet light, there is a problem in that range-finding light emitted to a subject may not be accurately reflected and a measured distance value may be incorrect in the range finding technique based on the ToF method. With the range finding technique based on the ToF method, there is a problem in that a measured distance value may be incorrect due to a difference in optical path between multiple paths.

When three-dimensional information of a subject is generated on the basis of distance images including an incorrect measured distance value, it is conceivable that an abnormal value be manually corrected. Since manual correction is troublesome, it is possible to exclude a corresponding pixel value and to generate three-dimensional information by knowing the degree of reliability of the measured distance value for each pixel. However, it is not easy to determine the degree of reliability of a measured distance value. Therefore, in order to generate correct three-dimensional information, there is demand for calculating the degree of reliability of a measured distance value for each pixel.

The present embodiment was made in consideration of the aforementioned circumstances, and an objective thereof is to provide a reliability calculation device, a three-dimensional generation device, and reliability calculation method that can calculate the degree of reliability of a measured distance value.

According to an aspect of the present embodiment, there is provided a reliability calculation device including a distance image acquiring unit configured to acquire a distance image including distance information at each of coordinates of a two-dimensional coordinate system, an IR image acquiring unit configured to acquire an IR image including information which corresponds to the distance image and which is information on the light intensity of infrared light at each of coordinates in the distance image, an ideal light intensity calculating unit configured to calculate an ideal light intensity based on the acquired distance information at each of coordinates in the distance image with reference to correlation data which is data obtained by measuring a correlation between the distance to an evaluation chart and a received light intensity using the evaluation chart having a specific reflectance in advance, and a calculation unit configured to calculate the degree of reliability at each of coordinates on the basis of the result of comparison between the ideal light intensity acquired by calculation and the light intensity of received infrared light included in the IR image at each of coordinates, wherein the evaluation chart is a gray chart with a plurality of different gray levels, wherein the correlation data is data in which a distance and a received light intensity are correlated for each gray level, wherein the reliability calculation device further comprises a selection unit configured to select an appropriate gray level out of the plurality of gray levels on the basis of the acquired distance information at each of coordinates in the distance image, and wherein the ideal light intensity calculating unit calculates the ideal light intensity on the basis of the data of a gray level selected by the selection unit.

According to another aspect of the present embodiment, there is provided a reliability calculation method including a distance image acquiring step of acquiring a distance image including distance information at each of coordinates of a two-dimensional coordinate system; an IR image acquiring step of acquiring an IR image including information which corresponds to the distance image and which is information on a light intensity of infrared light at each of coordinates in the distance image; an ideal light intensity calculating step of calculating an ideal light intensity based on the acquired distance information at each of coordinates in the distance image with reference to correlation data which is data obtained by measuring a correlation between a distance to an evaluation chart and a received light intensity using the evaluation chart having a specific reflectance in advance; and a calculation step of calculating a degree of reliability at each of coordinates on the basis of a result of comparison between the ideal light intensity acquired by calculation and a light intensity of received infrared light included in the IR image at each of coordinates, wherein the evaluation chart is a gray chart with a plurality of different gray levels, wherein the correlation data is data in which a distance and a received light intensity are correlated for each gray level, wherein the reliability calculation method further comprises a selection step of selecting an appropriate gray level out of the plurality of gray levels on the basis of the acquired distance information at each of coordinates in the distance image, and wherein the ideal light intensity calculating step calculates the ideal light intensity on the basis of the data of a gray level selected by the selection step.

According to the embodiments, it is possible to calculate the degree of reliability of a measured distance value.

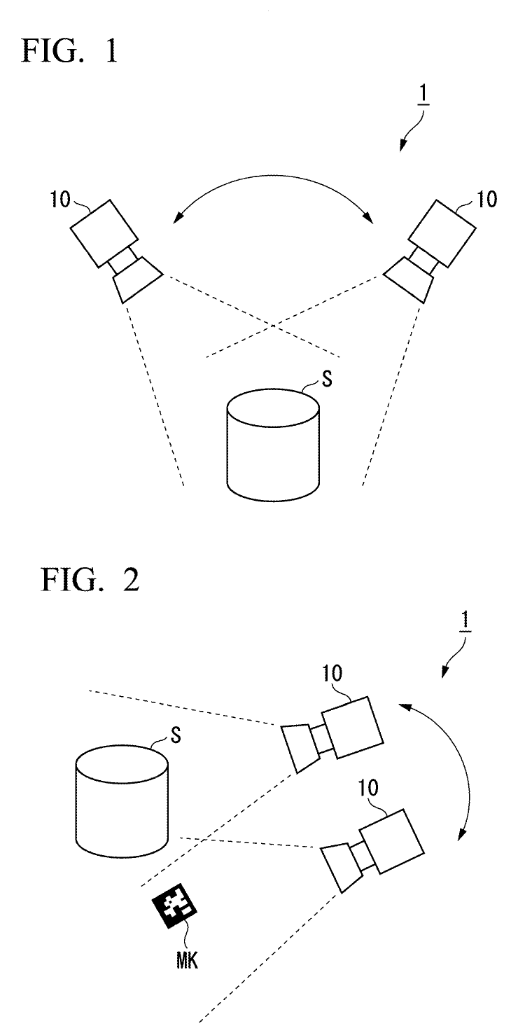

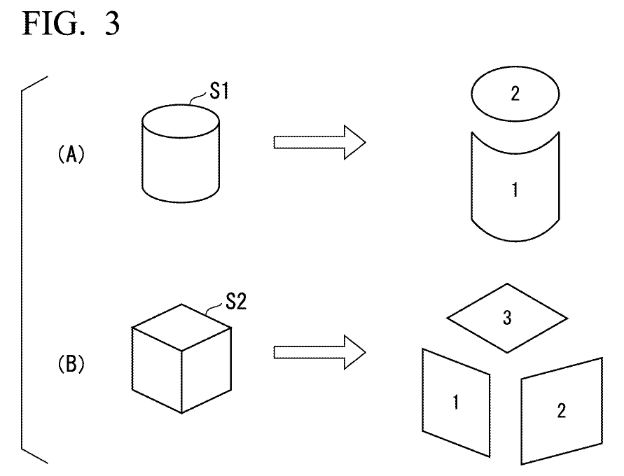

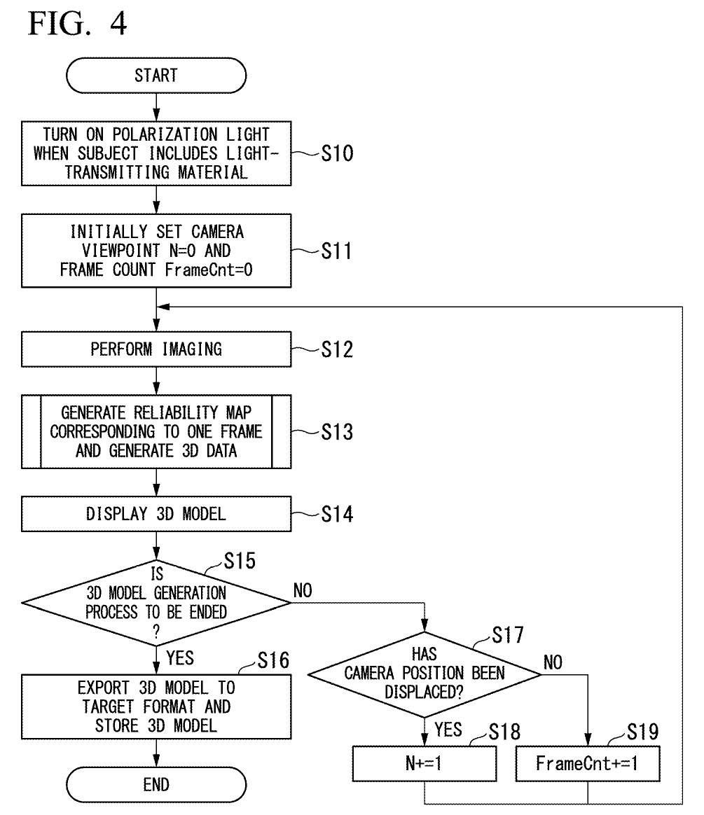

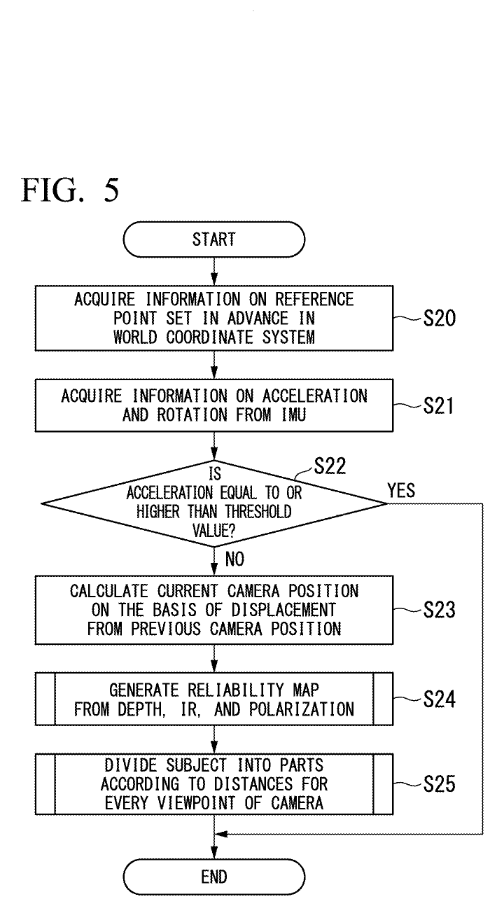

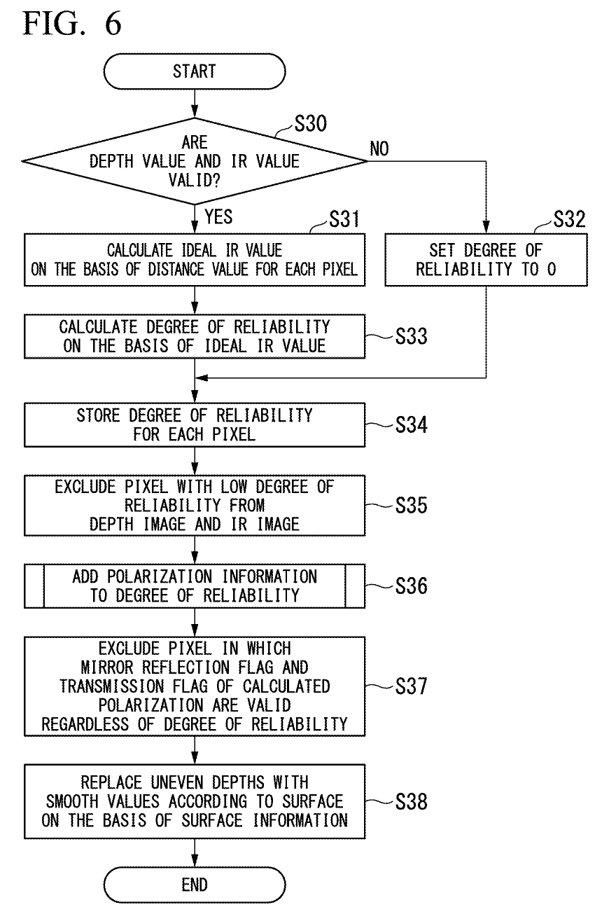

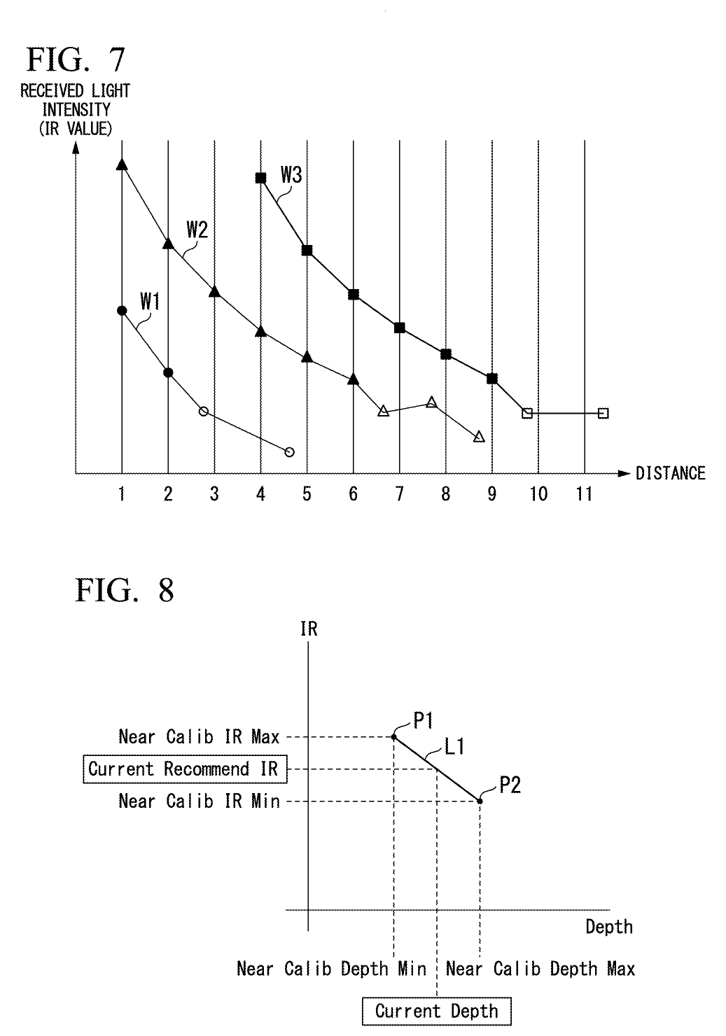

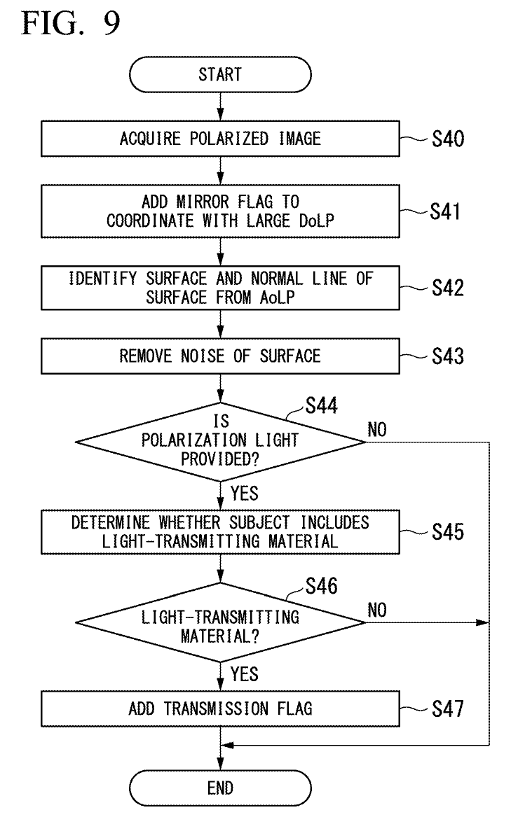

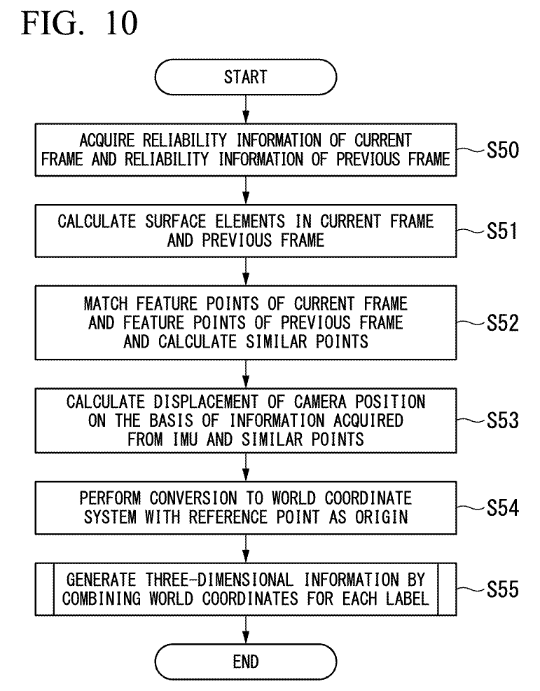

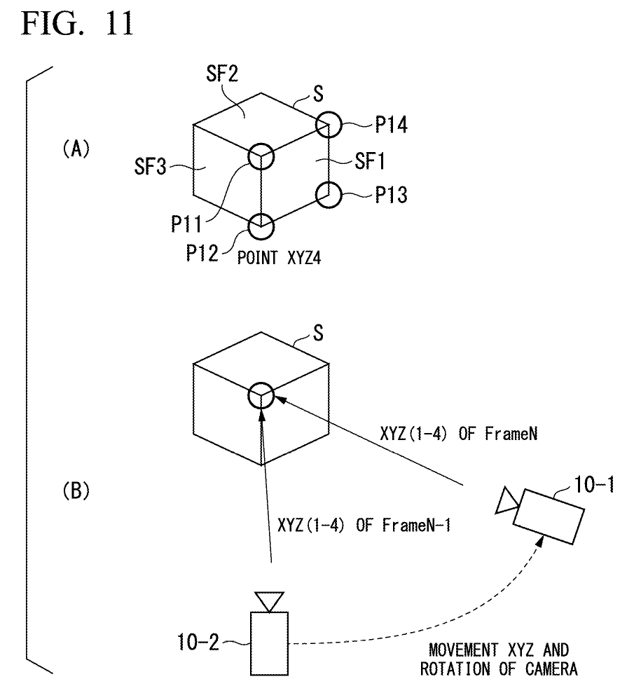

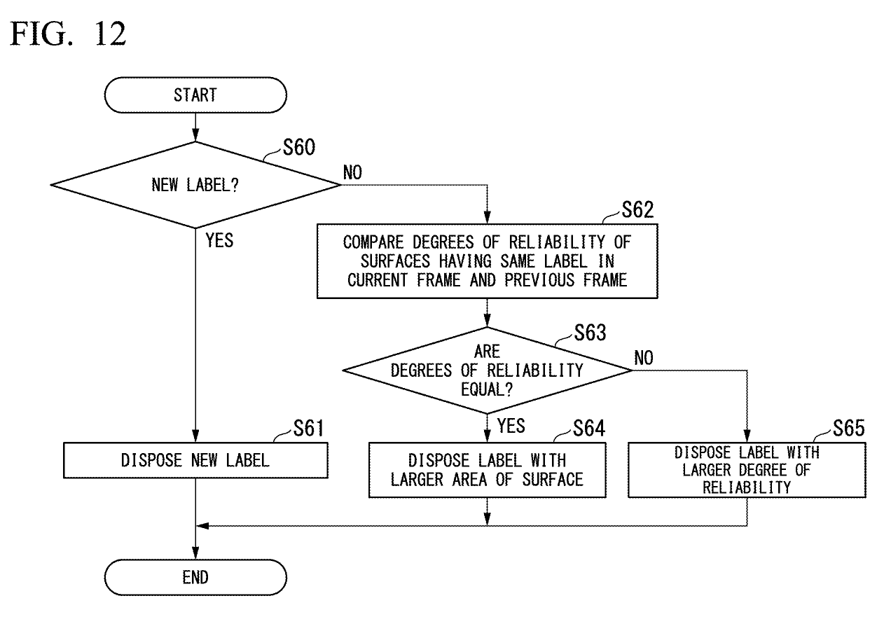

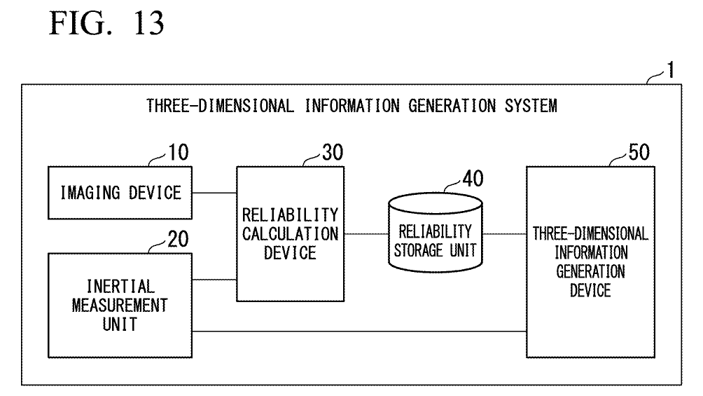

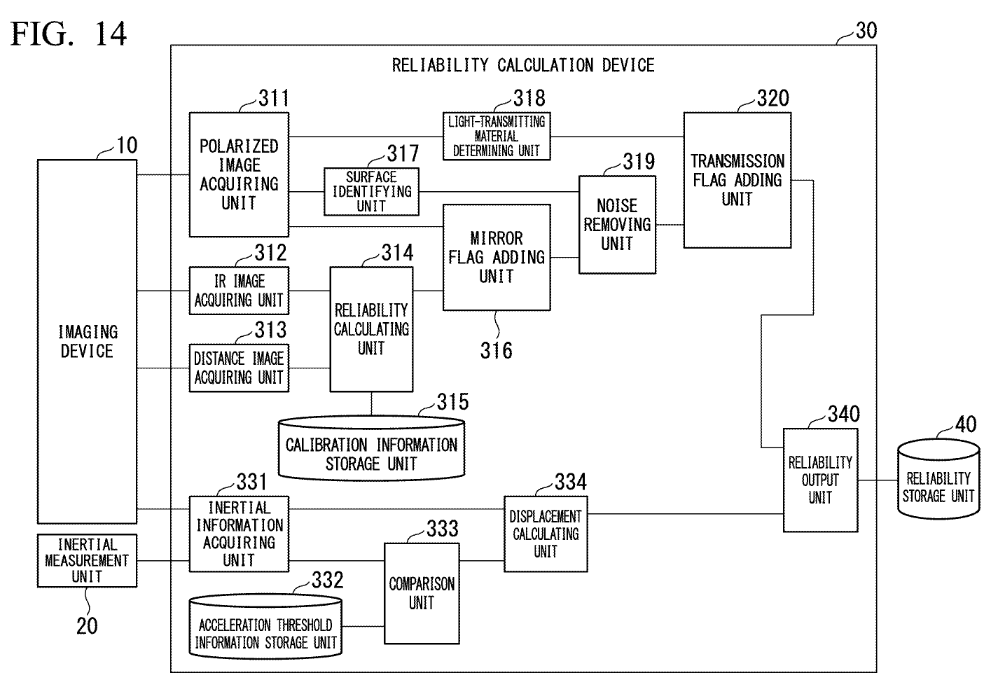

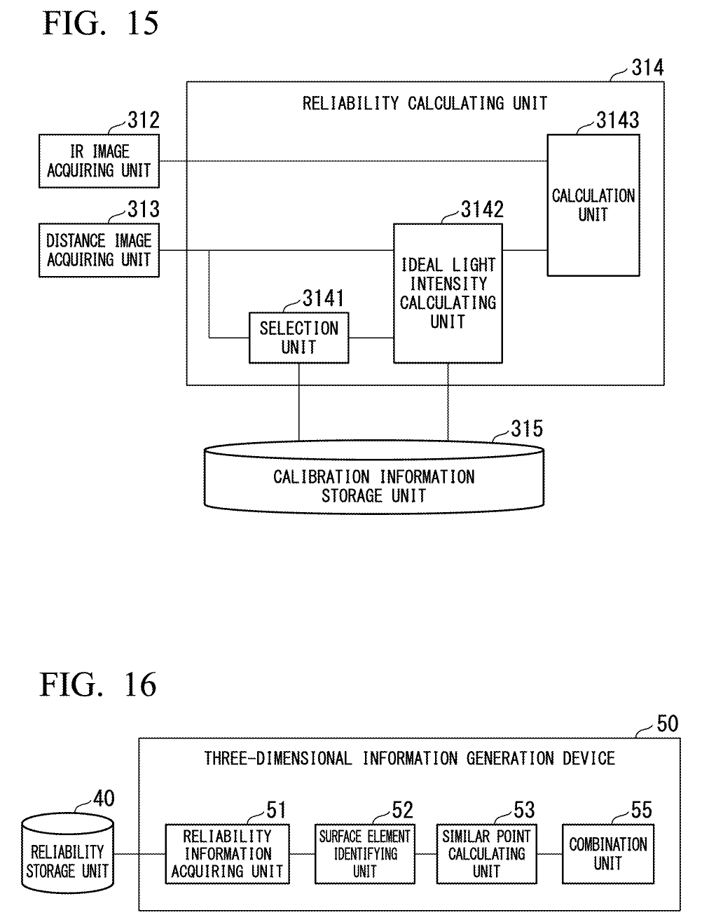

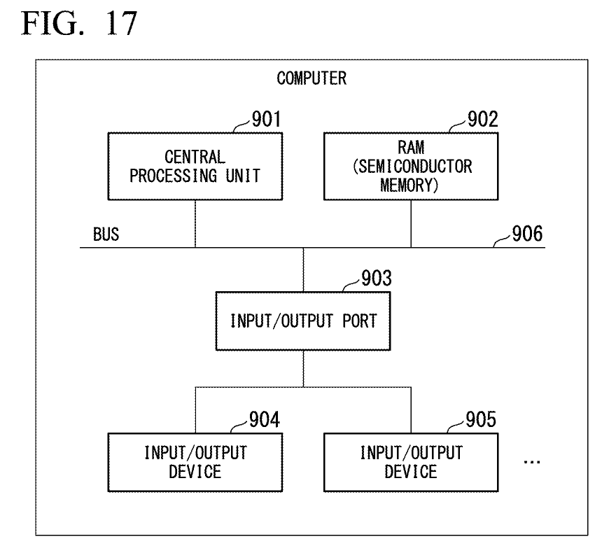

### BRIEF DESCRIPTION OF DRAWINGS

[FIG. 1] A first diagram schematically illustrating a three-dimensional information generation system according to an embodiment.

[FIG. 2] A second diagram schematically illustrating the three-dimensional information generation system according to the embodiment.

[FIG. 3] A diagram illustrating a three-dimensional information generation method that is performed by the three-dimensional information generation system according to the embodiment.

[FIG. 4] A first flowchart illustrating a flow of operations of the three-dimensional information generation system according to the embodiment.

[FIG. 5] A second flowchart illustrating a flow of operations of the three-dimensional information generation system according to the embodiment.

[FIG. 6] A third flowchart illustrating a flow of operations of the three-dimensional information generation system according to the embodiment.

[FIG. 7] A first diagram illustrating a method of calculating an ideal IR value according to the embodiment.

[FIG. 8] A second diagram illustrating a method of calculating an ideal IR value according to the embodiment.

[FIG. 9] A fourth flowchart illustrating a flow of operations of the three-dimensional information generation system according to the embodiment.

[FIG. 10] A fifth flowchart illustrating a flow of operations of the three-dimensional information generation system according to the embodiment.

[FIG. 11] A diagram illustrating feature points according to an embodiment.

[FIG. 12] A sixth flowchart illustrating a flow of operations of the three-dimensional information generation system according to the embodiment.

[FIG. 13] A functional configuration diagram illustrating an example of a functional configuration of the three-dimensional information generation system according to the embodiment.

[FIG. 14] A functional configuration diagram illustrating an example of a functional configuration of a reliability calculation device according to the embodiment.

[FIG. 15] A functional configuration diagram illustrating an example of a functional configuration of a reliability calculating unit according to the embodiment.

[FIG. 16] A functional configuration diagram illustrating an example of a functional configuration of a three-dimensional information generation device according to the embodiment.

[FIG. 17] A block diagram illustrating an example of an internal configuration of the reliability calculation device and the three-dimensional information generation device according to the embodiment.

### DESCRIPTION OF EMBODIMENTS

### [Embodiments]

Exemplary embodiments of a reliability calculation device, a three-dimensional generation device, and reliability calculation method according to an aspect of the present invention will be mentioned and described in detail below with reference to the accompanying drawings. The following embodiments are only examples, and the present invention is not limited to the embodiments. “On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information). In the drawings used for the following description, scales, numbers, and the like of constituent members may be made to be different from actual scales, numbers, and the like of the constituent members in order to make the constituent members be easily recognized.

### [Outline of three-dimensional information generation system]

First, an outline of a three-dimensional information generation system 1 according to an embodiment will be described with reference to FIGS. 1 to 3.

FIG. 1 is a first diagram schematically illustrating a three-dimensional information generation system according to an embodiment. The three-dimensional information generation system 1 generates three-dimensional information of a subject S. The three-dimensional information generation system 1 includes one or more imaging devices 10. The imaging device 10 is a device that can acquire a distance image, an IR image, a polarized image, and an RGB image. The distance image, the IR image, the polarized image, and the RGB image may have the same optical axis. That is, the imaging device 10 may include a time-of-flight (ToF) sensor for acquiring a distance image and an IR image, a polarization sensor for acquiring a polarized image, and an image sensor for acquiring an RGB image, and the sensors may be disposed at positions on which light incident on a lens is incident by dividing an optical path of the light incident on the lens. The present embodiment is not limited to an example in which the images have the same optical axis, and the distance image, the IR image, the polarized image, and the RGB image have only to have two-dimensional coordinate systems corresponding to each other.

The imaging device 10 acquires distance information from the imaging device 10 to a subject S, for example, using a ToF method. The imaging device 10 generates three-dimensional information of the subject S by acquiring distance information from a plurality of points (that is, a plurality of viewpoints) to the subject S and combining the acquired distance information. In the ToF method, infrared light is applied to the subject S, and the distance to the subject S is measured on the basis of a time until reflected light is received. In the following description, information on the light intensity of light received within a predetermined time after infrared light has been emitted by the ToF sensor may be referred to as an IR image.

The imaging device 10 may consecutively acquire distance information from a plurality of points to the subject S by consecutively capturing a frame image while moving an imaging point, for example, as indicated by an arrow in the drawing. Movement of the imaging device 10 may be identified, for example, on the basis of an acceleration, an angular velocity, or the like measured by an inertial measurement unit (IMU) (not illustrated) provided in the imaging device 10.

The imaging device 10 may acquire distance information from a plurality of points to the subject S by disposing different devices at two points illustrated in the drawing in advance and imaging the subject S from the points. In this case, it is preferable that the three-dimensional information generation system 1 acquire a positional relationship of the plurality of imaging devices 10 in advance. When the three-dimensional information generation system 1 includes the plurality of imaging devices 10, the number of imaging devices 10 is not limited, more information can be acquired using more imaging devices 10, and more accurate three-dimensional information can be generated.

FIG. 2 is a second diagram schematically illustrating the three-dimensional information generation system according to the embodiment. The drawing illustrates an example in which the three-dimensional information generation system 1 generates three-dimensional information using one imaging device 10. As illustrated in the drawing, a marker MK is placed before the subject S. The marker MK is used to identify a world coordinate system. Accordingly, it is preferable that the marker MK be imaged by the imaging device 10 such that a position and a direction thereof can be identified. The marker MK may be, for example, an identification code such as a QR code (registered trademark). The marker MK may be formed, for example, by printing an image indicating the identification code on a medium of paper or plastic.

The imaging device 10 images the marker MK in addition to the subject S. The imaging device 10 may capture the subject S and the marker MK independently (that is, an image in which the subject S is imaged and an image in which the marker MK is imaged as different frame images) or may capture an image in which both the subject S and the marker MK are imaged. For example, the imaging device 10 images the subject S from multiple viewpoints after imaging the marker MK. A world coordinate system may be set with a position at which the marker MK is imaged as an origin. That is, the three-dimensional information generation system 1 identifies the amount of movement of the imaging device 10 from the point at which the marker MK has been imaged on the basis of an acceleration, an angular velocity, or the like measured by the inertial measurement unit (not illustrated) and identifies the point (coordinates and a direction) at which the imaging device 10 has captured an image. In the present embodiment, the world coordinate system may be set using other method without necessarily using the marker MK.

FIG. 3 is a diagram illustrating a three-dimensional information generating method that is performed by the three-dimensional information generation system according to the embodiment. The three-dimensional information generation system 1 calculates the degree of reliability for each pixel and for each surface out of the acquired distance information of the subject S. Details of the reliability calculation method will be described later.

FIG. 3(A) illustrates an example in which the subject S is a subject S1 having a cylindrical shape. A surface to which reference sign 1 is added and a surface to which reference sign 2 is added are included as three-dimensional information of the subject S1. Three-dimensional information for each surface is acquired from an image with a higher degree of reliability of a corresponding surface out of images captured from multiple viewpoints by the imaging device 10. The three-dimensional information for the surfaces may be acquired from different images. The three-dimensional information generation system 1 generates the three-dimensional information of the subject S1 by combining the three-dimensional information for the surfaces acquired from different images.

FIG. 3(B) illustrates an example in which the subject S is a subject S2 having a cubic shape. A surface to which reference sign 1 is added, a surface to which reference sign 2 is added, and a surface to which reference sign 3 is added are included as three-dimensional information of the subject S2. Similarly, regarding the subject S2, three-dimensional information of the subject S is generated by acquiring three-dimensional information for the surfaces from different images and combining the three-dimensional information for the surfaces.

### [Operations of three-dimensional information generation system]

An example of the operations of the three-dimensional information generation system 1 according to the embodiment will be described below with reference to FIGS. 4 to 12.

FIG. 4 is a first flowchart illustrating the operations of the three-dimensional information generation system according to the embodiment. The drawing illustrates an example of regular operations that are performed by the three-dimensional information generation system 1. In the following description, a person who generates three-dimensional information of a subject S by operating the three-dimensional information generation system 1 may be referred to as an operator.

(Step S10) First, when a subject S includes a light-transmitting material, a polarization light (not illustrated) is turned on. The polarization light is included in the three-dimensional information generation system 1 and is installed at a position at which the subject S can be lighted. The polarization light may be provided in the imaging device 10. When it is determined that the subject S includes a light-transmitting material, for example, on/off control of the polarization light may be manually performed by an operator. The on/off control of the polarization light may be mechanically performed according to a result of analysis based on an IR image and a polarized image acquired by the imaging device 10.

(Step S11) The three-dimensional information generation system 1 performs initial setting of a camera viewpoint and a frame count. Specifically, a camera viewpoint N=0 and a frame count FrameCnt=0 are set as values thereof.

(Step S12) The imaging device 10 images the subject S. This imaging includes acquisition of a distance image, acquisition of an IR image, acquisition of a polarized image, and acquisition of an RGB image. In the following description, the distance image, the IR image, the polarized image, and the RGB image captured by the imaging device 10 may be simply referred to as an image when they are not distinguished.

(Step S13) The three-dimensional information generation system 1 generates a reliability map of the captured image. The reliability map is information in which the degree of reliability is added to each of coordinates in an image. The reliability map is generated for each of a plurality of images captured consecutively in time. A method of generating the reliability map will be described later with reference to FIG. 5 or the like. The three-dimensional information generation system 1 generates three-dimensional information of the subject S by selectively combining appropriate distance information on the basis of the generated reliability map.

(Step S14) The three-dimensional information generation system 1 displays the generated three-dimensional information (a 3D model) of the subject S. The three-dimensional information of the subject S is displayed, for example, on a display which is not illustrated. For example, the three-dimensional information of the subject S may be projected using a predetermined method in a visually recognizable manner. The operator ascertains the displayed three-dimensional information of the subject S.

(Step S15) The operator determines whether the three-dimensional information generating process is to be ended as a result of ascertainment of the displayed three-dimensional information of the subject S. The operator can continue to perform the three-dimensional information generating process, for example, when noise is superimposed on the displayed three-dimensional information and it is determined that a three-dimensional shape of the subject S is not sufficiently imaged (that is, different from an actual subject). When it is determined that the three-dimensional information generating process is to be ended (that is, Step S15: YES), the process flow proceeds to Step S16. When it is determined that the three-dimensional information generating process is not to be ended (that is, the three-dimensional information generating process continues to be performed) (that is, Step S15: NO), the process flow proceeds to Step S17.

(Step S16) The three-dimensional information generation system 1 exports the three-dimensional information in a target file format. The exported file is stored in a predetermined storage unit.

(Step S17) When the three-dimensional information generating process is continued, an imaging process is performed again by the imaging device 10. The imaging process may be performed with movement of the position of the imaging device 10 or may be performed without movement of the position of the imaging device 10. Movement of the position of the imaging device 10 is more preferable when distance information is not correctly acquired due to an imaging position, and movement of the position of the imaging device 10 is not necessary when distance information is not correctly acquired regardless of the imaging position. Whether the position of the imaging device 10 is to be moved may be determined, for example, on the basis of an acceleration, an angular velocity, or the like measured by the inertial measurement unit (not illustrated) provided in the imaging device 10. When it is determined that the position of the imaging device 10 is to be moved (that is, Step S17: YES), the process flow proceeds to Step S18. When it is determined that the position of the imaging device 10 is not to be moved (that is, Step S17: NO), the process flow proceeds to Step S19.

(Step S18) The three-dimensional information generation system 1 performs a process of incrementing a value of the camera viewpoint. Specifically, a process of setting the camera viewpoint N+=1 is performed.

(Step S19) The three-dimensional information generation system 1 performs a process of incrementing a value of the frame count. Specifically, a process of setting the frame count FrameCnt+=1 is performed.

FIG. 5 is a second flowchart illustrating the operations of the three-dimensional information generation system according to the embodiment. An example of the reliability map generating process will be described with reference to the drawing. The reliability map generating process is the process described above as Step S13.

(Step S20) The three-dimensional information generation system 1 acquires information on a reference point which is set in advance in the world coordinate system. The reference point may be the position of the marker MK described above with reference to FIG. 2. When the position of the marker MK has not been acquired, the three-dimensional information generation system 1 may instruct the operator to image the marker MK.

(Step S21) The three-dimensional information generation system 1 acquires information on acceleration and rotation or the like from the inertial measurement device (not illustrated) provided in the imaging device 10.

(Step S22) Here, when the acquired acceleration is equal to or greater than a threshold value, a camera shake may occur, and image information may not be correct (information of the subject S may not be appropriately acquired). Therefore, when the acquired acceleration is equal to or greater than the threshold value (that is, Step S22: YES), the three-dimensional information generation system 1 determines that the corresponding image is not used for the three-dimensional information generating process and ends the reliability map generating process. When the acquired acceleration is not equal to or greater than the threshold value (that is, Step S22: NO), the three-dimensional information generation system 1 continues to perform the reliability map generating process and causes the process flow to proceed to Step S23.

(Step S23) The three-dimensional information generation system 1 calculates a current camera position on the basis of displacement from a previous camera position and information on the reference point acquired in Step S20. The previous camera position may be a camera position at which a frame image acquired immediately before a target frame image which is being processed out of consecutive frame images has been captured. The current camera position may be a camera position at which the target frame image which is being processed has been captured.

(Step S24) The three-dimensional information generation system 1 calculates the degree of reliability when the subject S is imaged from the calculated camera position. Specifically, the three-dimensional information generation system 1 generates a reliability map on the basis of the distance image, the IR image, and the polarized image. Details of a specific method of generating the reliability map will be described later with reference to FIG. 6 or the like.

(Step S25) The three-dimensional information generation system 1 divides the subject S into parts for every camera position on the basis of the generated reliability map. Details of the parts division process on the subject S will be described later with reference to FIG. 11 or the like.

FIG. 6 is a third flowchart illustrating the operations of the three-dimensional information generation system according to the embodiment. An example of details of the reliability map generating process will be described with reference to the drawing. The details of the reliability map generating process are, that is, the process described above as Step S24.

(Step S30) First, the three-dimensional information generation system 1 determines whether a distance value and an IR value for each of coordinates are valid values on the basis of the distance image and the IR image. Whether the distance value and the IR value are valid has only to be determined on the basis of whether the values are less than a predetermined threshold value. Examples of the case in which the distance value and the IR value for each of coordinates are not valid include a case in which the values are abnormal values and a case in which a target pixel is a so-called dead pixel or a case in which the values become abnormal values due to superimposition of noise. When the distance value and the IR value for each of coordinates are valid (that is, Step S30: YES), the three-dimensional information generation system 1 causes the process flow to proceed to Step S31. When the distance value and the IR value for each of coordinates are not valid (that is, Step S30: NO), the three-dimensional information generation system 1 causes the process flow to proceed to Step S31.

(Step S31) Then, the three-dimensional information generation system 1 calculates an ideal IR value (the amount of received light) on the basis of the distance value for each pixel. Here, when the infrared reflectance of the subject S is constant, the IR value also varies with change of the distance to the subject S. Specifically, the amount of received light becomes smaller as the distance to the subject S becomes larger, and the amount of received light becomes larger as the distance to the subject S becomes smaller. When the distance to the subject S is constant, the amount of received light (the IR value) varies depending on the infrared reflectance of the subject S. Specifically, the amount of received light becomes smaller as the infrared reflectance of the subject S becomes lower, and the amount of received light becomes larger as the infrared reflectance of the subject S becomes higher.

According to the present embodiment, an ideal IR value based on the distance value to the subject S using characteristics that the IR value varies depending on the distance or the infrared reflectance of the subject S is calculated, and the degree of reliability is calculated on the basis of the ideal IR value and the actual IR value. The degree of reliability may be specifically a ratio of the actual IR value to the ideal IR value. A specific example of the method of calculating the ideal IR value (the amount of received light) will be described below with reference to FIGS. 7 and 8.

FIG. 7 is a first diagram illustrating the method of calculating an ideal IR value according to the embodiment. In the drawing, the horizontal axis represents the distance, and the vertical axis represents an IR value (the amount of received light). In the drawing, measurement results of three subjects with different values of infrared reflectance are indicated by a line W1, a line W2, and a line W3. The line W1 is lower in infrared reflectance, and the line W3 is higher in infrared reflectance. In the drawing, a blackened point is a point with a satisfactory IR value. On the other hand, an outlined point is a point with an unsatisfactory IR value.

The illustrated information is information which is acquired by measurement using an evaluation chart. The evaluation chart may be a gray chart including a plurality of different gray levels. When the evaluation chart is a gray chart, the line W1 is a chart with a gray level closer to black, and the line W3 is a chart with a gray level closer to white. The drawing illustrates an example in which the evaluation chart with three values of infrared reflectance is used. For example, when a gray chart with 16 grayscales is used, 16 lines are drawn. The illustrated information is measured, but the present embodiment is not limited to the example in which the information is acquired by measurement, and the correlation between the distance and an IR value has only to be calculated using any method.

In the illustrated example, values 1 to 11 described as distance values indicate relative distances (that is, there is no unit) for the purpose of simplification of explanation. In the measurement results, actual distance values may be used. The intervals between the distance values do not have to be equal, and information on a plurality of points has only to be present. For example, in a range with a small change in the amount of received light, the intervals do not have to be the same as the intervals in a range with a large change in the amount of received light.

The three-dimensional information generation system 1 acquires correlation information between the distance and the amount of received light illustrated in the drawing in advance by performing experiment or the like as preparation and stores the acquired information in a storage unit. In the present embodiment is not limited to the example in which the correlation information between the distance and the amount of received light is acquired by experiment or the like, and the correlation information may be acquired by simulation or the like.

The three-dimensional information generation system 1 calculates the ideal IR value for each pixel on the basis of the acquired distance image in a reliability calculating step. First, the three-dimensional information generation system 1 selects two pieces of data closest to a distance value at coordinates at which the degree of reliability is to be determined out of data stored in advance. In selecting data, data with high IR values is selected. Data with low values of infrared reflectance is selected. For example, in the illustrated example, appropriate data is retrieved from the line W1 with the lowest value of infrared reflectance, and appropriate data is retrieved from the line W2 with the second lowest value of infrared reflectance from the line W1 when appropriate data has not been retrieved. For example, when the distance value at a pixel to be processed is 3.5, appropriate data is not present on the line W1 (an outlined point), and two pieces of appropriate data are present on the line W2 (blackened points). More specifically, when the distance value at the pixel to be processed is 3.5, data in which the distance value is 3 and data in which the distance value is 4 are selected from the line W2.

In selection of data, when the reflectance of the subject S of which three-dimensional information is to be generated is known in advance, data close to the reflectance may be selected. The reflectance of the subject S may be selected by the operator or may be determined on the basis of the IR image or the RGB image captured by the imaging device 10 or the like.

FIG. 8 is a second diagram illustrating the method of calculating an ideal IR value according to the embodiment. In the drawing, the horizontal axis represents the distance, and the vertical axis represents an IR value (the amount of received light). In the drawing, two pieces of data selected on the basis of the distance values are illustrated as a point P1 and a point P2. Speaking in correlation with the description mentioned above with reference to FIG. 7, the point P1 is, for example, a point at which the distance value on the line W2 is 3, and the point P2 is, for example, a point at which the distance on the line W2 is 4. A line L1 is a segment connecting the point P1 and the point P2. The ideal IR value (a point referred to by Current Recommended IR in the drawing) is calculated on the basis of the distance value (a point referred to by Current Depth in the drawing) at the coordinate at which the ideal IR value is to be calculated and the line L1.

Referring back to FIG. 6, a process flow after the ideal IR value has been calculated will be described.

(Step S33) The three-dimensional information generation system 1 calculates the degree of reliability on the basis of the calculated ideal IR value. The degree of reliability may be a ratio of the distance value at the coordinate at which the degree of reliability is to be calculated to the ideal IR value at the coordinate at which the degree of reliability is to be calculated or the like. When the actual IR value is greater than the ideal IR value, an upper limit of the degree of reliability may be set to 100%, and a value greater than 100% may be cut out.

(Step S32) When it is determined in Step S30 that the pixel value is not a valid value, the degree of reliability is 0.

(Step S34) The three-dimensional information generation system 1 stores the degree of reliability calculated in Steps S31 and S32 for each pixel. In the following description, information including the degree of reliability for each pixel in a two-dimensional coordinate system is also referred to as a reliability map.

(Step S35) The three-dimensional information generation system 1 excludes a pixel in which the degree of reliability is less than a predetermined threshold value in the generated reliability map from the distance image and the IR image.

(Step S36) The three-dimensional information generation system 1 adds information based on the polarized image to the reliability map. Addition of information based on the polarized image will be described later with reference to FIG. 9. Here, mirror reflection may occur according to adjustment (state) of the reflectance of the subject S and the light emitted to the subject S. In this case, distance information may not be accurate. By performing the process of this step, a mirror reflection flag is added to a pixel at which mirror reflection is estimated. A light-transmitting member is used according to the subject S. In this case, the distance information may not be accurate. By performing the process of this step, a transmission flag is added to a pixel at which it is estimated to use a light-transmitting member.

(Step S37) The three-dimensional information generation system 1 excludes a pixel to which at least one of the mirror reflection flag and the transmission flag is added from the distance image and the IR image regardless of the degree of reliability.

(Step S38) The three-dimensional information generation system 1 performs a process of correcting unevenness for each surface of the subject S. Specifically, the three-dimensional information generation system 1 corrects unevenness by identifying a surface of the subject S and uniformly replacing a distance value with a smooth value along the surface. Replacement of a distance value may be correcting the pixel value excluded from the distance image and the IR image on the basis of pixel values near the corresponding pixel. Replacement of a distance value may be correcting the pixel value on the same surface on the basis of nearby pixel values.

FIG. 9 is a fourth flowchart illustrating the operations of the three-dimensional information generation system according to the embodiment. An example of the process of adding information based on a polarized image will be described below with reference to the drawing. Addition of information based on a polarized image is, that is, the process described above as Step S36.

(Step S40) First, a polarized image captured by the imaging device 10 is acquired. The polarized image corresponds to the distance image used to generate the reliability map in the aforementioned description.

(Step S41) The three-dimensional information generation system 1 separates a specular reflection component and a diffusive reflection component on the basis of the acquired polarized image. Here, at a coordinate with a high degree of linear polarization (DoLP), there is a high likelihood of mirror reflection. Accordingly, the three-dimensional information generation system 1 adds a mirror flag to the coordinate with a high DoLP.

(Step S42) Then, the three-dimensional information generation system 1 calculates a polarization direction from an angle of linear polarization (AoLP). The three-dimensional information generation system 1 identifies a surface of the subject S and a normal line of the surface on the basis of the calculated polarization direction and the DoLP. The identified surface is labeled (clustered). The same label (class) is added to images which are estimated to be the same surface in a plurality of consecutive images.

In the relationship between the DoLP and a reflection angle (an incidence angle), two reflection angles are estimated other than a Brewster’s angle (a polarization angle). In order to resolve this ambiguity, a close one may be selected by performing estimation of a normal line based on a tangent depth on the basis of information of a previous frame image and information of a current frame image.

(Step S43) The three-dimensional information generation system 1 performs noise removal on the identified surface.

(Step S44) Then, the three-dimensional information generation system 1 determines whether the subject S includes a light-transmitting material using a polarization light. However, some imaging devices 10 may include a polarization light, and other imaging devices 10 may not include a polarization light. Therefore, the three-dimensional information generation system 1 first determines whether the imaging device 10 includes a polarization light. When the imaging device 10 includes a polarization light (that is, Step S44: YES), the process flow proceeds to Step S45, and the process of determining whether the subject includes a light-transmitting material is performed. When the imaging device 10 does not include a polarization light (that is, Step S44: NO), the process flow ends.

(Step S45) The three-dimensional information generation system 1 determines whether the subject S includes a light-transmitting material. Since many light-transmitting materials change their optical characteristics, it can be determined whether the subject includes a light-transmitting material by illumination with the polarization light. Determination of whether the subject includes a light-transmitting material may be performed for each pixel or may be performed for each surface. Specifically, a passive IR image is used to determine whether the subject includes a light-transmitting material. The passive IR image may be specifically an image which is acquired using ambient light without radiating infrared light using the ToF sensor. When the imaging device 10 including a polarization light is used, the passive IR image is affected by reflected light from the polarization light. Therefore, the three-dimensional information generation system 1 determines whether the subject includes a light-transmitting material by calculating a reflection intensity from a light source on the basis of the passive IR image.

(Step S46) When it is determined that the subject includes a light-transmitting material (that is, Step S46: YES), the three-dimensional information generation system 1 causes the process flow to proceed to Step S47. When it is determined that the subject does not include a light-transmitting material (that is, Step S46: NO), the three-dimensional information generation system 1 ends the process flow.

(Step S47) The three-dimensional information generation system 1 adds a transmission flag to each pixel or each surface which is determined to include a light-transmitting material. Change in optical characteristics may appear in only a profile part depending on a shape of the light-transmitting material or the like. That is, even when the whole surface includes a light-transmitting material, the vicinity of an edge part of the surface may be determined to include a light-transmitting material, and a central part of the surface may not be determined to include a light-transmitting material. Accordingly, a transmission flag may be added to all pixels in the same surface as the surface including the pixel determined to include a light-transmitting material.

FIG. 10 is a fifth flowchart illustrating the operations of the three-dimensional information generation system according to the embodiment. An example of a parts division process for each camera viewpoint will be described below with reference to the drawing. The parts division process for each camera viewpoint is, that is, the process described above as Step S25.

(Step S50) First, the three-dimensional information generation system 1 acquires a reliability map of a current frame and a reliability map of a previous frame.

(Step S51) Then, the three-dimensional information generation system 1 acquires a surface element for the current frame and the previous frame. Whether an element is a surface can be determined on the basis of a distance image corresponding to the acquired reliability maps.

(Step S52) The three-dimensional information generation system 1 identifies a feature point on the basis of the distance image. A feature point is a point indicating a feature out of points constituting a surface. For example, four feature points are identified for each surface. The three-dimensional information generation system 1 identifies feature points of the current frame and feature points of the previous frame. The three-dimensional information generation system 1 calculates similar points by matching the identified feature points of the current frame with the identified feature points of the previous frame. Details of feature points will be described later with reference to FIG. 11.

FIG. 11 is a diagram illustrating feature points according to the embodiment. First, a specific example of feature points identified for each surface will be described with reference to FIG. 11(A). In the illustrated example, a subject S includes at least a surface SF1, a surface SF2, and a surface SF3. In the drawing, four feature points of the surface SF1 are illustrated. Specifically, the surface SF1 has a rectangular shape, and vertices P11 to P14 of the rectangular shape are identified as feature points. The number of feature points is not limited to four as illustrated in the drawing as long as they can be used to identify a surface. The number of feature points may vary between surfaces. For example, the number of feature points of a surface having a complicated shape may be large.

FIG. 11(B) is a diagram illustrating matching of the feature points of a current frame with the feature points of a previous frame. As illustrated in the drawing, the imaging device 10 images the subject S from a plurality of positions. In the illustrated example, the imaging device 10 images the subject S from a point referred to by reference sign 10-1 and a point referred to by reference sign 10-2. Even when imaging is performed from any point, feature points of the subject S are identified. The three-dimensional information generation system 1 acquires a similar point by matching the identified feature points of a current frame with the identified feature points of a previous frame.

(Step S53) Referring back to FIG. 10, the three-dimensional information generation system 1 calculates displacement of the imaging device 10 on the basis of information acquired from an inertial measurement unit provided in the imaging device 10 and the similar points calculated in Step S52. Displacement of the imaging device 10 is displacement from a point at which a target previous frame has been captured to a point at which a current frame is captured.

(Step S54) The three-dimensional information generation system 1 converts three-dimensional information of the subject S in the current frame to coordinates in the world coordinate system with a reference point as an origin. The coordinates in the world coordinate system are acquired in Step S20.

(Step S55) The three-dimensional information generation system 1 retrieves a frame image with a high degree of reliability for each label (that is, for each surface) from the target frame image and combines the three-dimensional information of the subject S using three-dimensional information of the corresponding surface. In other words, the three-dimensional information generation system 1 generates the three-dimensional information of the subject S by extracting three-dimensional information with a high degree of reliability from different frame images for each surface and combining the extracted three-dimensional information in the world coordinate system.

FIG. 12 is a sixth flowchart illustrating the operations of the three-dimensional information generation system according to the embodiment. An example of details of the three-dimensional information combining process will be described below with reference to the drawing. The three-dimensional information combining process is, that is, the process described above as Step S55.

(Step S60) The three-dimensional information generation system 1 determines whether a label included in the target frame image is a new label. A new label is a label which has not appeared while the three-dimensional information generation system 1 is processing a plurality of frame images. When the label is a new label (that is, Step S60: YES), the three-dimensional information generation system 1 causes the process flow to proceed to Step S61. When the label is not a new label (that is, Step S60: NO), the three-dimensional information generation system 1 causes the process flow to proceed to Step S62.

(Step S61) When the label is not a new label, the three-dimensional information generation system 1 disposes three-dimensional information of the surface to which the label is added in the world coordinate system.

(Step S62) When the label is a new label, the three-dimensional information generation system 1 compares the degree of reliability of a surface having the same label between the current frame and the previous frame. Comparison of the degree of reliability may be comparison of the degree of reliability of the surface which is calculated on the basis of an average or the like of the degrees of reliability at the coordinates included in the surface.

(Step S63) When the degrees of the surface having the same label in the current frame and the previous frame are the same (that is, Step S63: YES), the three-dimensional information generation system 1 causes the process flow to proceed to Step S64. When the degrees of the surface having the same label in the current frame and the previous frame are not the same (that is, Step S63: NO), the three-dimensional information generation system 1 causes the process flow to proceed to Step S65.

(Step S64) When the degrees of the surface having the same label in the current frame and the previous frame are the same, the label with a larger area of the surface is disposed. When the areas of the same surface are compared, this is because the surface with a larger area is estimated to be imaged from the more front side and is information with a higher degree of reliability.

(Step S65) When the degrees of the surface having the same label in the current frame and the previous frame are not the same, the label with a higher degree of reliability is disposed. This is because a higher degree of reliability means superimposition of less noise and three-dimensional information is estimated to be more accurately acquired.

### [Functional configuration of three-dimensional information generation system]

An example of the functional configuration of the three-dimensional information generation system 1 according to the embodiment will be described below with reference to FIGS. 13 to 16. The three-dimensional information generation system 1 which will be described below is an example of a specific configuration for realizing the three-dimensional information generating process.

FIG. 13 is a functional configuration diagram illustrating an example of the functional configuration of the three-dimensional information generation system according to the embodiment. An example of the functional configuration of the three-dimensional information generation system 1 will be described below with reference to the drawing. The three-dimensional information generation system 1 includes an imaging device 10, an inertial measurement unit 20, a reliability calculation device 30, a reliability storage unit 40, and a three-dimensional information generation device 50.

The imaging device 10 images a subject S. Images captured by the imaging device 10 include a distance image, an IR image, a polarized image, and an RGB image. It is preferable that two-dimensional coordinates in these images correspond to each other. The imaging device 10 consecutively captures an image. The consecutive images captured by the imaging device 10 can also be referred to as frame images. The imaging device 10 captures an image at a predetermined frame rate. The predetermined frame rate may be, for example, 1 [frames per second (FPS)] or 24 [FPS].

The inertial measurement unit 20 measures movement of the imaging device 10. The inertial measurement unit 20 may be provided as a constituent of the imaging device 10. Specifically, the inertial measurement unit 20 includes an acceleration sensor and a gyro sensor which are not illustrated and detects an acceleration and an angular velocity in three axes.

The reliability calculation device 30 calculates the degree of reliability at each of coordinates for each frame image on the basis of the images captured by the imaging device 10 and the acceleration and the angular velocity acquired by the inertial measurement unit 20. Information on the degree of reliability at each of coordinates for each image is also referred to as a reliability map. A specific configuration of the reliability calculation device 30 will be described later with reference to FIG. 14.

The reliability storage unit 40 stores the degree of reliability for each image calculated by the reliability calculation device 30. It can be said that a reliability map for a plurality of images (frame images) consecutive in time is stored in the reliability storage unit 40.

The three-dimensional information generation device 50 generates three-dimensional information of the subject S using a plurality of reliability maps which are calculated by the reliability calculation device 30 and stored in the reliability storage unit 40. The three-dimensional information generation device 50 identifies parts with high degrees of reliability for each element (for example, each surface) of the subject S with cross-compatible reference to the plurality of reliability maps consecutive in time. The three-dimensional information generation device 50 generates the three-dimensional information of the subject S by combining the identified parts with high degrees of reliability in the world coordinate system.

FIG. 14 is a functional configuration diagram illustrating an example of the functional configuration of the reliability calculation device according to the embodiment. An example of the functional configuration of the reliability calculation device 30 will be described below with reference to the drawing. The reliability calculation device 30 includes a polarized image acquiring unit 311, an IR image acquiring unit 312, a distance image acquiring unit 313, a reliability calculating unit 314, a calibration information storage unit 315, a mirror flag adding unit 316, a surface identifying unit 317, a light-transmitting material determining unit 318, a noise removing unit 319, a transmission flag adding unit 320, an inertial information acquiring unit 331, an acceleration threshold information storage unit 332, a comparison unit 333, a displacement calculating unit 334, and a reliability output unit 340. These functional units are realized, for example, using electronic circuits. Each functional unit may include a storage means such as a semiconductor memory or a magnetic hard disk device according to necessity. Each function may be realized by a computer including a central processing unit (CPU) and software.

Some constituents described as the functional constituents of the reliability calculation device 30 may be provided in another device (for example, the three-dimensional information generation device 50) provided in the three-dimensional information generation system 1.

The polarized image acquiring unit 311 acquires a polarized image captured by the imaging device 10. The polarized image includes polarization information of a subject S at each of coordinates in a two-dimensional coordinate system.

The IR image acquiring unit 312 acquires an IR image captured by the imaging device 10. The IR image includes information on the amount of received infrared light at each of coordinates in the two-dimensional coordinate system. The IR image may be acquired by acquiring the amount of infrared light (that is, ambient light) in a state in which light is not radiated using a ToF sensor.

The distance image acquiring unit 313 acquires a distance image (a depth image) captured by the imaging device 10. The distance image includes distance information from the imaging device 10 to the subject S at each of coordinates in the two-dimensional coordinate system. The distance information at each of coordinates may be referred to as a distance value or a depth value.

The coordinates in the polarized image, the IR image, and the distance image correspond to each other. It is preferable that the numbers of pixels (resolutions) in the polarized image, the IR image, and the distance image be the same, but the present invention is not limited to this example in which the numbers of pixels are the same. That is, the coordinates in the polarized image, the IR image, and the distance image do not have to correspond in a one-to-one manner and have only to correspond to each other.

The imaging device 10 images the subject S from a plurality of different points. The imaging device 10 may consecutively image the subject S while changing an imaging point. In the following description, for the purpose of simplification of explanation, it is assumed that the imaging device 10 images the subject S from a first point and a second point. A polarized image captured from the first point may be referred to as a first polarized image, an IR image captured from the first point may be referred to as a first IR image, and a distance image captured from the first point may be referred to as a first distance image. A polarized image captured from the second point different from the first point may be referred to as a second polarized image, an IR image captured from the second point may be referred to as a second IR image, and a distance image captured from the second point may be referred to as a second distance image.

The reliability calculating unit 314 acquires an IR image from the IR image acquiring unit 312 and acquires a distance image from the distance image acquiring unit 313. The reliability calculating unit 314 calculates the degree of reliability at each pixel on the basis of the acquired IR image and the acquired distance image. Calculation of the degree of reliability is performed with reference to correlation data. The correlation data is data obtained by measuring a correlation between the distance to an evaluation chart and the amount of received light using the evaluation chart with a specific value of reflectance in advance.

The calibration information storage unit 315 stores the correlation data measured in advance. The correlation data can also be said to indicate a correlation between the distance and an IR value which is measured using the evaluation chart. The evaluation chart used for measurement is preferably a gray chart having a plurality of different gray levels. When the gray chart is used for measurement, the correlation data is data in which the distance and the amount of received light are correlated for each gray level.

FIG. 15 is a functional configuration diagram illustrating an example of a functional configuration of the reliability calculating unit according to the embodiment. An example of the functional configuration of the reliability calculating unit 314 will be described below with reference to the drawing. The reliability calculating unit 314 includes a selection unit 3141, an ideal light intensity calculating unit 3142, and a calculation unit 3143.

The selection unit 3141 acquires a distance image from the distance image acquiring unit 313. The selection unit 3141 selects an appropriate gray level out of the plurality of gray levels on the basis of the distance information at each of coordinates in the acquired distance image. Selection of a gray level is also selecting data corresponding to a value of infrared reflectance of the subject S. Selection of a gray level is performed with reference to the correlation information stored in the calibration information storage unit 315. When the value of infrared reflectance of the subject S is known, the selection unit 3141 may select a gray level corresponding to the value of infrared reflectance of the subject S.

The ideal light intensity calculating unit 3142 calculates an ideal light intensity at each of coordinates on the basis of the data selected by the selection unit 3141 and a distance value in the distance image acquired by the distance image acquiring unit 313. Calculation of an ideal light intensity is performed with reference to the correlation data stored in the calibration information storage unit 315.

The calculation unit 3143 calculates the degree of reliability at each of coordinates (that is, a reliability map) on the basis of a result of comparison between the ideal light intensity at each of coordinates calculated by the ideal light intensity calculating unit 3142 and the amount of received infrared light included in the IR image acquired by the IR image acquiring unit 312. Referring back to FIG. 14, the reliability map calculated by the reliability calculating unit 314 is output to the mirror flag adding unit 316.

The mirror flag adding unit 316 acquires a polarized image from the polarized image acquiring unit 311 and acquires a reliability map from the reliability calculating unit 314. The mirror flag adding unit 316 adds a mirror flag for each of coordinates to the reliability map on the basis of the acquired polarized image. The mirror flag adding unit 316 may specifically add a mirror flag to a coordinate with a large DoLP.

The surface identifying unit 317 acquires a polarized image from the polarized image acquiring unit 311 and identifies a surface of the subject S on the basis of the acquired polarized image. The surface identifying unit 317 may calculate a polarization direction on the basis of the AoLP and identify a surface of the subject S on the basis of the calculated polarization direction and the DoLP. The surface identifying unit 317 performs labeling (clustering) for each identified surface.

The light-transmitting material determining unit 318 acquires a polarized image from the polarized image acquiring unit 311 and determines whether the subject includes a light-transmitting material on the basis of the acquired polarized image. It is preferable that determination of whether the subject includes a light-transmitting material be performed for each pixel. The result of determination of whether the subject includes a light-transmitting material for each pixel may be reflected in the surface identified by the surface identifying unit 317.

The noise removing unit 319 acquires information indicating a labeled surface from the surface identifying unit 317 and acquires information on the reliability map to which the mirror flag has been added from the mirror flag adding unit 316. The noise removing unit 319 removes distance information at coordinates to which a polarization flag has been added from the distance information at each of coordinates in the distance image. The noise removing unit 319 smooths unevenness of the surface by complementing the removed distance information in a range which is identified as a surface by the surface identifying unit 317.

The transmission flag adding unit 320 acquires a reliability map from which noise has been removed from the noise removing unit 319 and acquires information on the result of determination of whether the subject includes a light-transmitting material from the light-transmitting material determining unit 318. The transmission flag adding unit 320 adds a transmission flag to coordinates determined to include a light-transmitting material out of the coordinates of the reliability map from which noise has been removed. The transmission flag adding unit 320 outputs the reliability map to which the transmission flag has been added to the reliability output unit 340.

The inertial information acquiring unit 331 acquires information on movement of the imaging device 10 from the inertial measurement unit 20. Specifically, the distance image acquiring unit 313 acquires information on an acceleration and an angular velocity in three axes or the like. The inertial information acquiring unit 331 may acquire information on the timing at which an image has been captured by the imaging device 10. The inertial information acquiring unit 331 acquires information on the movement of the imaging device 10 in a time period after a first image has been captured by the imaging device 10 and until a second image has been captured by acquiring the information on the timing at which an image has been captured by the imaging device 10.

The acceleration threshold information storage unit 332 stores information on an acceleration threshold value. The acceleration threshold value is an acceleration serving as a limit to which a normal image is recognized. That is, when the acceleration acquired by the inertial information acquiring unit 331 is equal to or higher than the acceleration threshold value, the corresponding image is estimated not to be a normal image (for example, a blurred image).

The comparison unit 333 compares the acceleration threshold value stored in the acceleration threshold information storage unit 332 with the acceleration acquired by the inertial information acquiring unit 331. The comparison unit 333 outputs the result of comparison to the displacement calculating unit 334. That is, the result of comparison indicates whether a corresponding image is a normal image.

The displacement calculating unit 334 acquires the information on movement of the imaging device 10 between frame images from the inertial information acquiring unit 331 and acquires information on the result of determination of whether the corresponding image is a normal image from the comparison unit 333. When the corresponding image is a normal image, the displacement calculating unit 334 calculates displacement of the imaging device 10 between the frame images. The displacement calculating unit 334 outputs information on the displacement of the imaging device 10 between the frame images acquired as the result of calculation to the reliability output unit 340. When the corresponding image is not a normal image, the comparison unit 333 or the displacement calculating unit 334 may notify the reliability calculating unit 314 or the like that the process of calculating a reliability map is stopped.

The reliability output unit 340 acquires a reliability map from the transmission flag adding unit 320 and acquires information on the displacement of the imaging device 10 from the displacement calculating unit 334. The reliability output unit 340 stores the acquired information in the reliability storage unit 40 in correlation. The reliability map and the information on the displacement of the imaging device 10 are correlated for each frame image and stored in the reliability storage unit 40. An RGB image or a distance image corresponding to the reliability map or the like in addition to the reliability map and the information on the displacement of the imaging device 10 may be correlated and stored in the reliability storage unit 40.

FIG. 16 is a functional configuration diagram illustrating an example of a functional configuration of the three-dimensional information generation device according to the embodiment. An example of the functional configuration of the three-dimensional information generation device 50 will be described below with reference to the drawing. The three-dimensional information generation device 50 includes a reliability information acquiring unit 51, a surface element identifying unit 52, a similar point calculating unit 53, and a combination unit 55. These functional units are realized, for example, using electronic circuits. Each functional unit may include a storage means such as a semiconductor memory or a magnetic hard disk device according to necessity. Each function may be realized by a computer including a CPU and software.

The three-dimensional information generation device 50 generates three-dimensional information of the subject S on the basis of the degree of reliability for each of a plurality of frame images stored in the reliability storage unit 40 and the information on displacement of the imaging device 10. Specifically, the three-dimensional information generation device 50 compares the degree of reliability at a first viewpoint and the degree of reliability at a second viewpoint and generates three-dimensional information on the basis of a distance image with a high degree of reliability. The three-dimensional information generation device 50 can generate three-dimensional information with high reliability by selectively using distance information with a high degree of reliability from the plurality of frame images.

The reliability information acquiring unit 51 acquires a reliability map stored in the reliability storage unit 40. The reliability information acquiring unit 51 acquires the information on displacement of the imaging device 10, information on an RGB image, or the like which is correlated with the reliability map.

The surface element identifying unit 52 identifies a surface element on the basis of the distance image corresponding to the acquired reliability map. As the surface element, for example, a surface in which distance information is continuous (a surface in which distance information is not discrete) may be identified. The surface element identifying unit 52 identifies feature points for identifying a surface.

The similar point calculating unit 53 calculates similar points on the basis of feature points in a current frame image and feature points in a previous frame image. By calculating the similar points, it is possible to match the current frame image and the previous frame image.

The combination unit 55 generates three-dimensional information of the subject S by selectively extracting distance information for a surface from a frame image with a highest degree of reliability out of a plurality of frame images according to the matched result and combining distance information on the extracted surface. The generated three-dimensional information is presented to an operator.

FIG. 17 is a block diagram illustrating an example of an internal configuration of the reliability calculation device 30 and the three-dimensional information generation device 50 according to the present embodiment. An internal configuration of one of the reliability calculation device 30 and the three-dimensional information generation device 50 is illustrated in the drawing. Both the reliability calculation device 30 and the three-dimensional information generation device 50 may have the internal configuration illustrated in the drawing as a hardware configuration. At least some functions of the reliability calculation device 30 and the three-dimensional information generation device 50 can be realized using a computer. As illustrated in the drawing, the computer includes a central processing unit 901, a RAM 902, an input/output port 903, an input/output device 904 or 905, and a bus 906. The computer itself can be realized using a known technique. The central processing unit 901 executes instructions included in a program read from the RAM 902 or the like. The central processing unit 901 writes data to the RAM 902, reads data from the RAM 902, or performs an arithmetic operation or a logic operation in accordance with the instructions. The RAM 902 stores data or programs. Each element included in the RAM 902 has an address and can be accessed using the address. RAM is an abbreviation to “random access memory.” The input/output port 903 is a port that is used for the central processing unit 901 to exchange data with an external input/output device or the like. The input/output device 904 or 905 is an input/output device. The input/output device 904 or 905 exchanges data with the central processing unit 901 via the input/output port 903. The bus 906 is a shared communication path used in the computer. For example, the central processing unit 901 reads or writes data to or from the RAM 902 via the bus 906. For example, the central processing unit 901 accesses the input/output port via the bus 906.

### [Conclusion of embodiment]

According to the aforementioned embodiment, the reliability calculation device 30 includes the distance image acquiring unit 313 to acquire a distance image including distance information at each of coordinates of a two-dimensional coordinate system, the IR image acquiring unit 312 to acquire an IR image including information which corresponds to the distance image and which is information on the light intensity of infrared light at each of coordinates in the distance image, the ideal light intensity calculating unit 3142 to calculate an ideal light intensity based on the acquired distance information at each of coordinates in the distance image with reference to correlation data which is data obtained by measuring a correlation between the distance to an evaluation chart and the received light intensity using the evaluation chart having a specific reflectance in advance, and the calculation unit 3143 to calculate the degree of reliability at each of coordinates on the basis of a result of comparison between the ideal light intensity acquired by calculation and the light intensity of received infrared light included in the IR image at each of coordinates. The reliability calculation device 30 can calculate the degree of reliability of a distance value for each pixel by employing this configuration. By generating three-dimensional information based on the degrees of reliability calculated by the reliability calculation device 30, since three-dimensional information of a subject can be generated except for inaccurate distance values, it is possible to generate three-dimensional information with high accuracy from which an abnormal value due to noise or the like has been excluded.

According to the aforementioned embodiment, the evaluation chart is a gray chart with a plurality of different gray levels, and the correlation data is data in which the distance and the received light intensity are correlated for each gray level. The reliability calculation device 30 further includes the selection unit 3141 to select an appropriate gray level out of the plurality of gray levels on the basis of the acquired distance information at each of coordinates in the distance image, and the ideal light intensity calculating unit 3142 calculates the ideal light intensity on the basis of the data of a gray level selected by the selection unit 3141. Here, the received light intensity varies according to an infrared reflectance of a subject S. With the reliability calculation device 30, the degree of reliability is calculated by comparing the light intensity acquired by imaging with an ideal light intensity for each infrared reflectance measured in advance. Accordingly, according to the present embodiment, it is possible to accurately calculate the degree of reliability.

According to the aforementioned embodiment, the three-dimensional information generation device 50 generates three-dimensional information using the reliability calculation device 30. The distance image acquiring unit 313 acquires a first distance image including distance information from a first point to a subject and a second distance image including distance information from a second point which is a point different from the first point to the subject, and the IR image acquiring unit 312 acquires a first IR image corresponding to the first distance image and a second IR image corresponding to the second distance image. The three-dimensional information generation device 50 compares the degree of reliability based on the first distance image and the first IR image and the degree of reliability based on the second distance image and the second IR image and generates three-dimensional information on the basis of the distance image with a higher degree of reliability. Accordingly, the three-dimensional information generation device 50 can generate three-dimensional information of a subject on the basis of distance information with a high degree of reliability and thus generate three-dimensional information with high accuracy from which an abnormal value due to noise or the like has been excluded.

According to the aforementioned embodiment, the three-dimensional information generation device 50 further includes the polarized image acquiring unit 311 to acquire a polarized image including information which corresponds to the distance image and which is polarization information of the subject at each of coordinates in the distance image, includes the mirror flag adding unit 316 to add a mirror flag at each of coordinates on the basis of the acquired polarized image, includes the noise removing unit 319 to remove distance information at the coordinate to which the mirror flag has been added out of the distance information at the coordinates in the distance image, and includes the surface identifying unit 317 to identify a surface on the basis of the acquired polarized image. The three-dimensional information generation device 50 generates three-dimensional information by complementing the removed distance information in a range identified by the surface to smooth unevenness of the surface. Accordingly, even when a subject S includes a material which a ToF sensor has difficulty handling such as a mirror surface, it is possible to generate accurate three-dimensional information of the subject S.

All or some of the functions of the constituent units of the three-dimensional information generation system 1 according to the embodiment may be realized by recording programs for realizing the functions on a computer-readable recording medium and causing a computer system to read and execute the programs recorded on the recording medium. The “computer system” mentioned herein includes an OS or hardware such as peripherals.

The “computer-readable recording medium” is a portable medium such as a flexible disk, a magneto-optical disc, a ROM, or a CD-ROM or a storage unit such as a hard disk incorporated into a computer system. The “computer-readable recording medium” may also include a medium that dynamically hold a program for a short time such as a communication line when the program is transmitted via a network such as the Internet or a communication line such as a telephone line or a medium that holds a program for a predetermined time such as a volatile memory in a computer system serving as a server or a client in that case. The program may be a program for realizing some of the aforementioned functions or may be a program for realizing the aforementioned functions in combination with another program stored in advance in the computer system.

While embodiments of the present invention have been described above, the present invention is not limited to the embodiments, and various modifications may be added thereto without departing from the gist of the present invention. The aforementioned embodiments may be appropriately combined.

### INDUSTRIAL APPLICABILITY

According to the present invention, it is possible to calculate the degree of reliability of a measured distance value.

### REFERENCE SIGNS LIST

1 Three-dimensional information generation system

10 Imaging device

20 Inertial measurement unit

30 Reliability calculation device

40 Reliability storage unit

50 Three-dimensional information generation device

311 Polarized image acquiring unit

312 IR image acquiring unit

313 Distance image acquiring unit

314 Reliability calculating unit

315 Calibration information storage unit

316 Mirror flag adding unit

317 Surface identifying unit

318 Light-transmitting material determining unit

319 Noise removing unit

320 Transmission flag adding unit

331 Inertial information acquiring unit

332 Acceleration threshold information storage unit

333 Comparison unit

334 Displacement calculating unit

340 Reliability output unit

3141 Selection unit

3142 Ideal light intensity calculating unit

3143 Calculation unit

51 Reliability information acquiring unit

52 Surface element identifying unit

53 Similar point calculating unit

55 Combination unit

S Subject

MK Marker

What is claimed is::

1. A reliability calculation device comprising:
a distance image acquiring unit configured to acquire a distance image including distance information at each of coordinates of a two-dimensional coordinate system; an IR image acquiring unit configured to acquire an IR image including information which corresponds to the distance image and which is information on a light intensity of infrared light at each of coordinates in the distance image;
an ideal light intensity calculating unit configured to calculate an ideal light intensity based on the acquired distance information at each of coordinates in the distance image with reference to correlation data which is data obtained by measuring a correlation between a distance to an evaluation chart and a received light intensity using the evaluation chart having a specific reflectance in advance; and a calculation unit configured to calculate a degree of reliability at each of coordinates on the basis of a result of comparison between the ideal light intensity acquired by calculation and a light intensity of received infrared light included in the IR image at each of coordinates,
wherein the evaluation chart is a gray chart with a plurality of different gray levels, wherein the correlation data is data in which a distance and a received light intensity are correlated for each gray level, wherein the reliability calculation device further comprises a selection unit configured to select an appropriate gray level out of the plurality of gray levels on the basis of the acquired distance information at each of coordinates in the distance image, and wherein the ideal light intensity calculating unit calculates the ideal light intensity on the basis of the data of a gray level selected by the selection unit.

2. A three-dimensional information generation device that generates three-dimensional information using the reliability calculation device according to claim 1,
wherein the distance image acquiring unit acquires a first distance image including distance information from a first point to a subject and a second distance image including distance information from a second point which is a point different from the first point to the subject,
wherein the IR image acquiring unit acquires a first IR image corresponding to the first distance image and a second IR image corresponding to the second distance image, and wherein a degree of reliability based on the first distance image and the first IR image and a degree of reliability based on the second distance image and the second IR image are compared and three-dimensional information is generated on the basis of the distance image with a higher degree of reliability.

3. The three-dimensional information generation device according to claim 2, further comprising:
a polarized image acquiring unit configured to acquire a polarized image including information which corresponds to the distance image and which is polarization information of the subject at each of coordinates in the distance image;
a mirror flag adding unit configured to add a mirror flag at each of coordinates on the basis of the acquired polarized image;
noise removing unit configured to remove distance information at the coordinate to which the mirror flag has been added out of the distance information at the coordinates in the distance image; and
a surface identifying unit configured to identify a surface on the basis of the acquired polarized image,
wherein three-dimensional information is generated by complementing the removed distance information in a range identified by the surface to smooth unevenness of the surface.

4. A reliability calculation method comprising:
a distance image acquiring step of acquiring a distance image including distance information at each of coordinates of a two-dimensional coordinate system;
an IR image acquiring step of acquiring an IR image including information which corresponds to the distance image and which is information on a light intensity of infrared light at each of coordinates in the distance image;
an ideal light intensity calculating step of calculating an ideal light intensity based on the acquired distance information at each of coordinates in the distance image with reference to correlation data which is data obtained by measuring a correlation between a distance to an evaluation chart and a received light intensity using the evaluation chart having a specific reflectance in advance; and
a calculation step of calculating a degree of reliability at each of coordinates on the basis of a result of comparison between the ideal light intensity acquired by calculation and a light intensity of received infrared light included in the IR image at each of coordinates,
wherein the evaluation chart is a gray chart with a plurality of different gray levels,
wherein the correlation data is data in which a distance and a received light intensity are correlated for each gray level,
wherein the reliability calculation method further comprises a selection step of selecting an appropriate gray level out of the plurality of gray levels on the basis of the acquired distance information at each of coordinates in the distance image, and
wherein the ideal light intensity calculating step calculates the ideal light intensity on the basis of the data of a gray level selected by the selection step.
